(19) United States
(12) Patent Application Publication
(10) Pub. No.: US 2016/0068045 A1
(43) Pub. Date: Mar. 10, 2016

(54) RIDER COOLING DEVICE

(71) Applicant: Bruce Hammond, Aurora, CO (US)

(72) Inventor: Bruce Hammond, Aurora, CO (US)

(21) Appl. No.: 14/590,078

(22) Filed: Jan. 6, 2015

Related U.S. Application Data
(63) Continuation-in-part of application No. 14/479,620, filed on Sep. 8, 2014.

(51) Int. Cl. B60H 1/24

(52) U.S. Cl. CPC B60H 1/242

(57) ABSTRACT

A rider cooling device configured to provide cooled air to a vehicle rider are described that include using a fan that is mountable on a motorcycle, an all-terrain vehicle, a utility task vehicle, or other vehicle where space and energy can be limited. The rider cooling device may thus provide directed air for cooling a vehicle rider. In an implementation, the rider cooling device that employs example techniques in accordance with the present disclosure includes a turbo fan assembly including a fan motor, a fan coupled to the fan motor, and a fan housing; and a turbo fan assembly handlebar support member coupled to the turbo fan assembly, where the turbo fan assembly handlebar support member is configured to couple to a vehicle handlebar on a vehicle.

### RELATED APPLICATIONS

The present application is a continuation-in-part of U.S. patent application Ser. No. 14/479,620 filed on Sep. 8, 2014 and titled “MOTORCYCLE AIR CONDITIONING AND COOLING DEVICE.” U.S. patent application Ser. No. 14/479,620 is hereby incorporated by reference in its entirety.

### BACKGROUND

Convection can include a concerted, collective movement of molecules within a fluid (e.g., liquids, gases). This movement of fluid, such as air, can serve to facilitate convective heat transfer and/or evaporative cooling. Evaporative cooling can include the addition of water vapor into air by evaporating water (e.g., sweat, perspiration), which causes a lowering of the temperature of the object (e.g., a person). The energy needed to evaporate the water is taken from the object in the form of sensible heat, which affects the temperature of the object, and converted into latent heat, the energy present in the water vapor component of the air.

### SUMMARY

A rider cooling device configured to provide cooled air to a vehicle rider are described that include using a fan that is mountable on a motorcycle, an all-terrain vehicle, a utility task vehicle, or other vehicle where space and energy can be limited. The rider cooling device may thus provide directed air for cooling a vehicle rider. In an implementation, the rider cooling device that employs example techniques in accordance with the present disclosure includes a turbo fan assembly including a fan motor, a fan coupled to the fan motor, and a fan housing; and a turbo fan assembly handlebar support member coupled to the turbo fan assembly, where the turbo fan assembly handlebar support member is configured to couple to a vehicle handlebar on a vehicle. In an implementation, a rider cooling device includes a turbo fan assembly including a fan motor, a fan coupled to the fan motor, and a fan housing; and a turbo fan assembly handlebar support member coupled to the turbo fan assembly, where the turbo fan assembly handlebar support member is configured to couple to a vehicle handlebar on a vehicle; and a power source coupled to the fan motor. In another implementation, the rider cooling device includes a turbo fan assembly including a fan motor, a fan coupled to the fan motor, and a fan housing; and a turbo fan assembly handlebar support member coupled to the turbo fan assembly, where the turbo fan assembly handlebar support member is configured to couple to a vehicle handlebar on a vehicle; a controller coupled to the turbo fan assembly configured to operate the turbo fan assembly; and a sensor coupled to the controller.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. The use of the same reference numbers in different instances in the description and the figures may indicate similar or identical items.

FIG. 1 is an environment view illustrating a rider cooling device utilizing a mounted fan in accordance with an exemplary implementation of the present disclosure.

FIG. 2 is an environment view illustrating a rider cooling device utilizing a mounted fan in accordance with an exemplary implementation of the present disclosure.

FIG. 3 is an environment view illustrating a rider cooling device utilizing a mounted fan in accordance with an exemplary implementation of the present disclosure.

### DETAILED DESCRIPTION

### Overview

Convection can include a concerted, collective movement of molecules within a fluid (e.g., liquids, gases). This movement of fluid, such as air, can serve to facilitate convective heat transfer and/or evaporative cooling. Evaporative cooling can include the addition of water vapor into air by evaporating water (e.g., sweat, perspiration), which causes a lowering of the temperature of the object (e.g., a person). The energy needed to evaporate the water is taken from the object in the form of sensible heat, which affects the temperature of the object, and converted into latent heat, the energy present in the water vapor component of the air.

Oftentimes, motorcycle riders and other vehicle riders exposed to the outside environment can find it difficult to thermoregulate their body temperature, especially when riding in hot climates or cooler climates. For example, a motorcycle rider may endure excessive heat when riding a motorcycle in stop-and-go city traffic in a hot climate. In this instance, additional air convection, such as a fan directing ambient air onto the motorcycle rider, can make the ride more comfortable.

Accordingly, a rider cooling device configured to provide cooled air to a vehicle rider are described that include using a fan that is mountable on a motorcycle, an all-terrain vehicle, a utility task vehicle, or other vehicle where space and energy can be limited. The rider cooling device may thus provide directed air for cooling a vehicle rider. In an implementation, the rider cooling device that employs example techniques in accordance with the present disclosure includes a turbo fan assembly including a fan motor, a fan coupled to the fan motor, and a fan housing; and a turbo fan assembly handlebar support member coupled to the turbo fan assembly, where the turbo fan assembly handlebar support member is configured to couple to a vehicle handlebar on a vehicle. In an implementation, a rider cooling device includes a turbo fan assembly including a fan motor, a fan coupled to the fan motor, and a fan housing; and a turbo fan assembly handlebar support member coupled to the turbo fan assembly, where the turbo fan assembly handlebar support member is configured to couple to a vehicle handlebar on a vehicle; and a power source coupled to the fan motor. In another implementation, the rider cooling device includes a turbo fan assembly including a fan motor, a fan coupled to the fan motor, and a fan housing; and a turbo fan assembly handlebar support member coupled to the turbo fan assembly, where the turbo fan assembly handlebar support member is configured to couple to a vehicle handlebar on a vehicle; a controller coupled to the turbo fan assembly configured to operate the turbo fan assembly; and a sensor coupled to the controller.

### Example Implementations

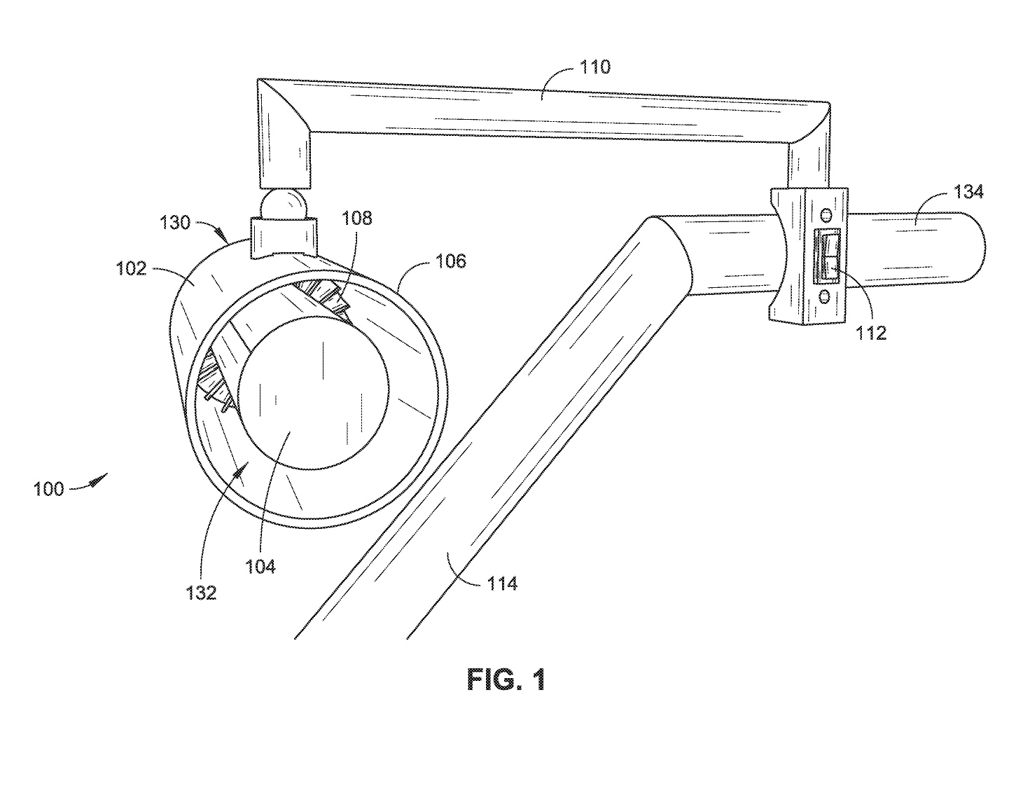

FIGS. 1 through 3 illustrate a rider cooling device 100 in accordance with example implementations of the present disclosure. The rider cooling device 100 can be used to direct cooled and/or ambient air onto a vehicle rider, such as a motorcycle rider, an all-terrain vehicle rider, and/or a utility task-type vehicle rider. This is advantageous, especially in warm weather, because it can be difficult to cool a rider or user when exposed to the outside environment, especially in warmer geographical areas. Additionally, the small form-factor and reduced energy requirement of the rider cooling device 100 can be optimized and/or configured for a smaller vehicle (e.g., a motorcycle, etc.).

As illustrated in FIGS. 1 through 3, the rider cooling device 100 includes a turbo fan assembly 102. The turbo fan assembly 102 can include a fan 108 with a fan motor 104 and a fan housing 106. In implementations, the fan 108 and/or fan motor 104 can include an electric-type turbo fan and/or a turbo bilge fan configured to function as an in-line blower. In an embodiment, an electric turbo bilge fan utilized in the turbo fan assembly 102 can include an electric fan with a diameter between approximately 2 inches to approximately 6 inches, where the fan is configured to require approximately 12 volts. In other specific embodiments, the turbo fan assembly 102 can require different voltages, such as 6 volts or 3 volts. It is contemplated that the turbo fan assembly 102 can require other voltages. The fan 108 can be housed within the turbofan assembly 102, which can additionally include fan housing 106 configured to cover, house, and protect the fan 108 and/or the fan motor 104 and provide a pathway where air can enter an air intake 130 of the turbo fan assembly 102, and be moved out an air exhaust 132 and directed to a vehicle rider or user.

The turbo fan assembly includes fan housing 106, which can be constructed from materials such as metal and/or a polymer or plastic. In one embodiment, the fan housing 102 is constructed from polyvinyl chloride-based material that is chosen for its strength and light weight characteristics. In another specific embodiment, the fan housing 102 can include a lightweight metal material, such as sheet metal and/or aluminum formed in the desired form (e.g., a tube or cylinder) to house the fan 108 and/or the fan motor 104. Additionally, the fan housing 102 may include directional blades and/or turning-vanes disposed on the end of the fan housing 102 proximate to the air exhaust 132, where the directional blades and/or turning-vanes can be adjusted to alter and/or adjust the air flow direction. In some implementations, the fan housing 102 can include angled sections, such as a 90° elbow. Other angled sections may also be utilized in the fan housing 102, such as a 45° section, a 20° section, and/or a 10° section.

In further embodiments, the fan housing 102 can include a filter that can function to filter particulates and/or other material from the air flow through the turbo fan assembly 102. Some examples of filters can include a particulate air filter and/or an allergen air filter. The filter may be disposed anywhere in the turbo fan housing (e.g., proximate to the air intake 130, proximate to the air exhaust 132, proximate to the fan 108, etc.).

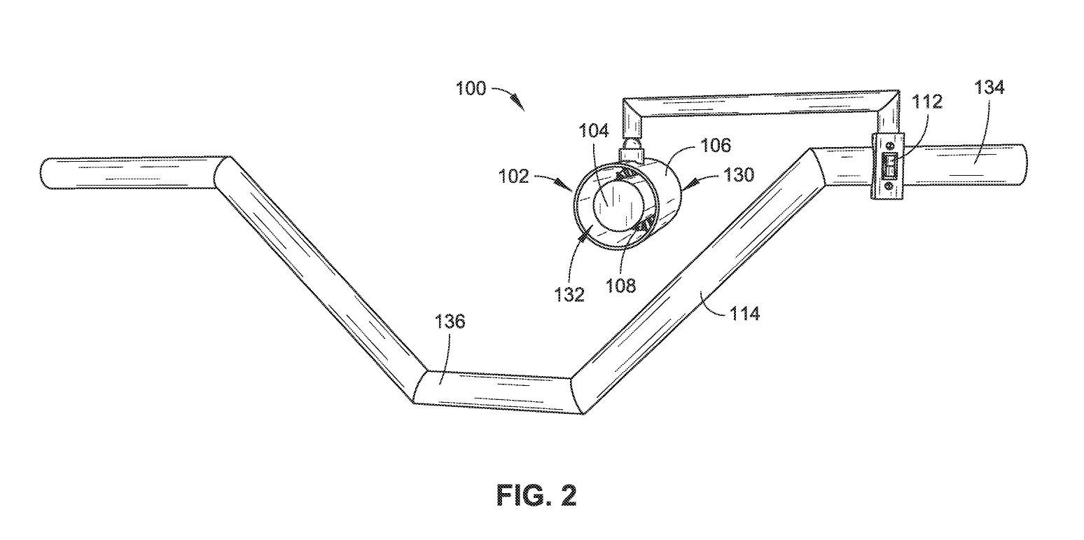

Additionally, the rider cooling device 100 can include means for coupling the turbo fan assembly 102 to a motorcycle or other vehicle. In one implementation, means for coupling the turbo fan assembly 102 to a motorcycle can include a handlebar support member 110. For example, the handlebar support member 110 can include an arm and/or a bar that couples to the turbo fan assembly 102 and a handlebar 114 disposed on the motorcycle and/or other vehicle. As shown in FIGS. 1 and 2, the handlebar support member 110 can include means for coupling the turbo fan assembly 102 to the handlebar support member 110. In some embodiments, the means for coupling the turbo fan assembly 102 to the handlebar support member 110 can include a clamp, a swivel assembly, at least one magnet, and/or a welded connection. In the embodiment shown in FIGS. 1 and 2, the means for coupling includes a swivel-type connection. In implementations, the handlebar support member 110 can include means for coupling the handlebar support member 110 to a handlebar 114. For example, the means for coupling the handlebar support member 110 to a handlebar 114 may include a clamp, a welded connection, at least one magnet, and/or other means. It is contemplated that a wide variety of connection means may be included with the handlebar support member 110. As shown in FIGS. 1 and 2, the handlebar support member 110 can be coupled to the handlebar 114 near a handle 134. However, the handlebar support member 110 may be coupled to the handlebar 114 in other locations, positions, and/or configurations. In a specific example, the handlebar support member 110 may be coupled to the handlebar 114 proximate to the center 136 of the handlebar 114. The handlebar support member 110 can be configured to be portable, movable, and/or flexible depending on the needs of a rider cooling device 100 user. The rider cooling device 100 may include a turbo fan assembly 102 configured to be coupled to a vehicle 116 other ways. For example, the turbo fan assembly 102 may include a magnetic assembly with at least one magnet configured for coupling the turbo fan assembly 102 to a metal portion of the vehicle (e.g., a gas tank, the frame, etc.).

As illustrated in FIGS. 1 and 2, the rider cooling device 100 may include a switch 112. In some implementations, the switch 112 may be a stand-alone device. For example, a stand-alone switch 112 can be disposed proximate to the rider cooling device 100, the turbo fan assembly 102, the handlebar support member 110, the handlebar 114, or anywhere on the vehicle 116. In other implementations, the switch 112 can be disposed and included as part of another component, such as the turbo fan assembly 102 and/or the handlebar support member 110. As shown in FIGS. 1 and 2, the switch 112 can be included as a part of the handlebar support member 110 disposed proximate to the handlebar 114. In implementations, the switch 112 can include an electrical component capable of breaking an electrical circuit. Some examples of a switch 112 can include a toggle switch, a push-button switch, and/or a rocker switch. It is contemplated that a variety of other switch types may be used as switch 112.

In one specific embodiment, the rider cooling device 100 can include at least one sensor 128. The sensor 128 may include a means for inputting information, such as a knob and/or push button input. Some examples of a sensor 128 that may be used can include a temperature sensor (e.g., thermometer, thermocouple, infrared thermometer, etc.) and/or an airflow sensor. For example, the turbo fan assembly 102 can include at least one thermocouple for measuring the temperature of the air and an airflow sensor for measuring the air flow rate through the turbo fan assembly 102. In this example, the speed of the fan motor 104 can be adjusted by controller 118 depending on the desired cooling temperature setting(s). In implementations, sensor 128 can be communicatively coupled to the controller 118 and/or a user interface.

In one embodiment, the rider cooling device 100 may include a power supply 126. In implementations, the power supply 126 can include an electronic device that supplies electrical energy to the turbo fan assembly 102 and/or other devices included as part of the rider cooling device 100. In one example, the power supply 126 can include a vehicle electromechanical system (e.g., a generator, an alternator). In this example, the vehicle (e.g., a motorcycle) can include an alternator that is electrically coupled to the turbo fan assembly 102. When the vehicle supplies power to the turbo fan assembly 102, the power supply may include electrical wiring and routing configured to provide electricity. In another example, the power supply 126 can include an energy storage device (e.g., a battery). In one specific embodiment, the power supply 126 can include a rechargeable battery 126 disposed within the turbo fan assembly 102. In implementations, the power supply 126 can be configured to operate with different types of voltages and can include a power converter configured to convert electrical energy from one form to another (e.g., AC to DC, DC to AC, change voltage, change frequency, etc.). For example, the power supply 126 can be configured to operate within a direct current 12 volt system. Additionally, the power supply 126 can operate with other voltages, such as 6 volt systems.

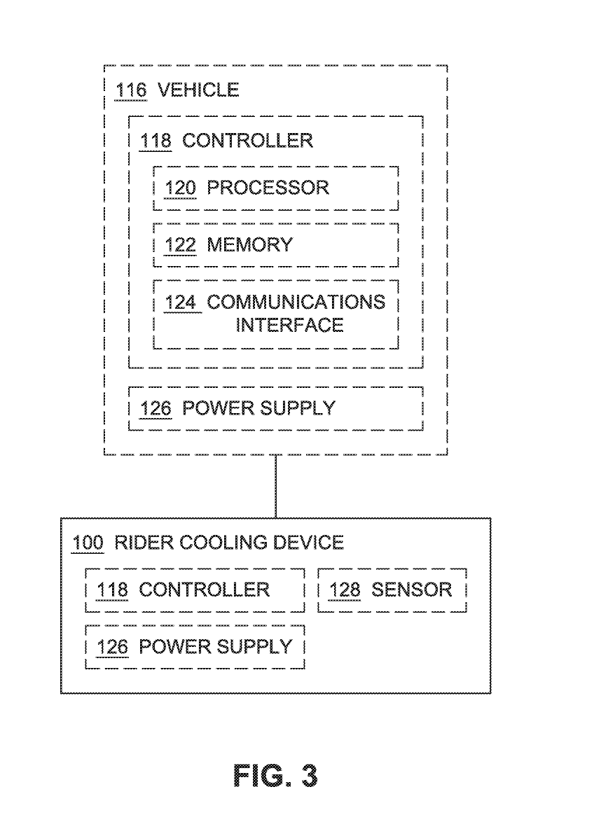

As illustrated in FIG. 3, a controller 118 may be included in and/or coupled to the rider cooling device 100. In some implementations and as shown in FIG. 3, the controller 118 can be included in a vehicle 116 (e.g., a motorcycle, an all-terrain vehicle, a utility task vehicle, a vehicle where the operator is exposed to outside air, etc.). In other implementations, also shown in FIG. 3, the controller can be included as a component of the rider cooling device 100. The controller 118 may provide a user interface (e.g., a touch interface or other control interface including switches, dials, inputs, an LED display, gauges, etc.) for a rider to control the functions and/or operation of the rider cooling device 100, such as inputting a desired temperature setting and/or turning the rider cooling device 100 on or off. In some implementations, the controller 118 may include a touch interface configured as a touch screen (e.g., a touch panel overlaying a display) that can detect a touch input within the area of the display for entry of information and commands. In implementations, the touch screen may employ a variety of technologies for detecting touch inputs. For example, the touch screen may employ infrared optical imaging technologies, resistive technologies, capacitive technologies, surface acoustic wave technologies, and so forth. In some implementations, buttons, keypads, knobs, dials, and so forth, may be used for entry of data and commands instead of, or in addition to, a touch screen. The controller 118 can include a processor 120, memory 122, a communication interface 124, and/or a sensor 128.

As illustrated in FIG. 3, the controller 118 can include a processor 120. The processor 120 provides processing functionality for the rider cooling device 100 and may include any number of processors, micro-controllers, or other processing systems and resident or external memory for storing data and other information accessed or generated by the rider cooling device 100. The processor 120 may execute one or more software programs which implement techniques described herein. The processor 120 is not limited by the materials from which it is formed or the processing mechanisms employed therein and, as such, may be implemented via semiconductor(s) and/or transistors (e.g., electronic integrated circuits (ICs)), and so forth.

As shown in FIG. 3, the memory 122 is an example of computer-readable media that provides storage functionality to store various data associated with the operation of the rider cooling device 100, such as software programs and code segments for controlling and/or operating the turbo fan assembly 102, the sensor 128, and/or other electronic components, or other data to instruct the processor 120 and other elements of the rider cooling device 100 to perform the functionality described herein. Although a single memory 122 is shown, a wide variety of types and combinations of memory may be employed. The memory 122 may be integral with the processor 120, stand-alone memory, or a combination of both. The memory 122 may include, for example, removable and non-removable memory elements, such as random-access memory (RAM), read-only memory (ROM), flash memory (e.g., a secure digital (SD) card, a mini-SD card, and/or a micro-SD card), magnetic memory, optical memory, universal serial bus (USB) memory, and so forth

The controller 118 can include a communication interface 124. The communication interface 124 is operatively configured to communicate with components of the rider cooling device 100. For example, the communication interface 124 can be configured to transmit data for storage in the rider cooling device 100, retrieve data from storage in the rider cooling device 100, and so forth. The communication interface 124 is also communicatively coupled with the processor 120 to facilitate data transfer between components of the rider cooling device 100 and the processor 120 (e.g., for communicating inputs to the processor 120 received from a device communicatively coupled with the rider cooling device 100 and/or controller 118). It should be noted that while the communication interface 124 is described as a component of controller 118, one or more components of the communication interface 124 can be implemented as external components communicatively coupled to the rider cooling device 100 via a wired and/or wireless connection. The rider cooling device 100 can also comprise and/or connect to one or more input/output (I/O) devices (e.g., via the communication interface 124), including, but not necessarily limited to: a display, a touchpad, a keypad, and so on.

The communication interface 124 and/or the processor 120 can be configured to communicate with a variety of different networks, including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communication interface 124 can be configured to communicate with a single network or multiple networks across different access points.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to: a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block, or circuit may be implemented using its software or firmware equivalent. In other instances, one part of a given system, block, or circuit may be implemented in software or firmware, while other parts are implemented in hardware.

### CONCLUSION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A rider cooling device configured to provide cooled air to a vehicle rider, comprising:
a turbo fan assembly including
a fan motor,
a fan coupled to the fan motor, and
a fan housing; and
a turbo fan assembly handlebar support member coupled to the turbo fan assembly, where the turbo fan assembly handlebar support member is configured to couple to a vehicle handlebar on a vehicle.

2. The rider cooling device in claim 1, wherein the vehicle is at least one of a motorcycle, an all-terrain vehicle, or a utility task vehicle.

3. The rider cooling device in claim 1, wherein the turbo fan assembly includes a turbo bilge fan.

4. The rider cooling device in claim 3, wherein the turbo fan bilge fan has a diameter between two inches and six inches.

5. The rider cooling device in claim 1, wherein the turbo fan assembly is capable of altering exhaust air direction.

6. The rider cooling device in claim 1, wherein the fan housing includes a magnetic assembly configured to couple the fan housing to a motorcycle.

7. The rider cooling device in claim 1, wherein the fan housing includes a metal-based housing.

8. A rider cooling device, comprising:
a turbo fan assembly including
a fan motor,
a fan coupled to the fan motor, and
a fan housing; and
a turbo fan assembly handlebar support member coupled to the turbo fan assembly, where the turbo fan assembly handlebar support member is configured to couple to a vehicle handlebar on a vehicle; and
a power source coupled to the fan motor.

9. The rider cooling device in claim 8, wherein the turbo fan assembly includes a turbo bilge fan.

10. The rider cooling device in claim 8, wherein the vehicle is at least one of a motorcycle, an all-terrain vehicle, or a utility task vehicle.

11. The rider cooling device in claim 8, wherein the turbo fan assembly includes a turbo bilge fan.

12. The rider cooling device in claim 8, wherein the turbo fan bilge fan has a diameter between two inches and six inches.

13. The rider cooling device in claim 8, wherein the fan housing includes a magnetic assembly configured to couple the fan housing to a motorcycle.

14. The rider cooling device in claim 8, wherein the fan housing includes a metal-based housing.

15. The rider cooling device in claim 8, wherein the power source includes a battery.

16. The rider cooling device in claim 8, wherein the power source includes a vehicle alternator.

17. A rider cooling device, comprising:
a turbo fan assembly including
a fan motor,
a fan coupled to the fan motor, and
a fan housing; and
a turbo fan assembly handlebar support member coupled to the turbo fan assembly, where the turbo fan assembly handlebar support member is configured to couple to a vehicle handlebar on a vehicle;
a controller coupled to the turbo fan assembly configured to operate the turbo fan assembly; and
a sensor coupled to the controller.

18. The rider cooling device in claim 17, wherein the turbo fan assembly includes a turbo bilge fan.

19. The rider cooling device in claim 17, wherein the sensor includes a temperature sensor.

20. The rider cooling device in claim 17, further comprising a power source coupled to the fan motor.
